(19) United States
(12) Patent Application Publication
(10) Pub. No.: US 2005/0082901 A1
(43) Pub. Date: Apr. 21, 2005

(54) Hubcap with fastening elements coupled therein

(76) Inventors: Jose Caldes Sabanes, Barcelona (ES); Augusto Mayer Pujadas, San Cugat Del Valles (ES)

Correspondence Address: KLAUBER & JACKSON, 411 Hackensack Avenue, Hackensack, NJ, 07601, US

(21) Appl. No.: 10/949,024

(22) Filed: Sep. 24, 2004

Related U.S. Application Data
(63) Continuation of application No. PCT/ES03/00138, filed on Mar. 24, 2003.

(30) Foreign Application Priority Data
Mar. 25, 2002 (ES) P200200704

(51) Int. Cl. B60B 7/14

(52) U.S. Cl. 301/37.372

(57) ABSTRACT

The invention relates to a hub cap with built-in rim-fixing screws, of the type that comprises a wheel cover which Covers all or part of the metal rim of the wheel and which comprises a series of tubular projections or cylindrical sleeves that are used to house a nut or screw for fixing the wheel to the cap. The aforementioned sleeve comprises an element which is used to fix the nut or screw permanently to the hubcap. Said element is formed by a peripheral lip on the inner surface of the sleeve which is housed in a cylindrical neck or groove of the screw, said groove being defined between two end stops. The above-mentioned fixing means enables the screw or nut to be moved in an axial manner between two defined positions, without allowing said screw or nut to be removed fully- from the hubcap, an operation which can only be carried out using an applicable tool.

### RELATED APPLICATIONS

The present application is a Continuation of co-pending PCT Application No. PCT/ES03/00138, filed Mar. 24, 2003, which in turn, claims priority from Spanish Application Serial No. 200200704, filed Mar. 25, 2002. Applicants claim the benefits of 35 U.S.C. §120 as to the PCT application and priority under 35 U.S.C. §119 as to said Spanish application, and the entire disclosures of both applications are incorporated herein by reference in their entireties.

This application for Invention Patent concerns the registration of a hubcap with fastening screws coupled therein intended to be fastened to the wheel rim, which incorporates notable innovations and advantages compared to present hubcaps and fastening systems for the wheel of a vehicle or automobile to the hub of the suspension.

More specifically, the new invention consists of a hubcap comprising within itself a set of screws or nuts necessary for the fastening of the wheel to the hub of the suspension assembly. These screws are respectively housed in a tubular alignment sleeve with a retaining system by means of an encircling lip housed in the interior of a throat existing in the said nut or screw.

### BACKGROUND OF THE INVENTION

Hubcaps and wheel trim are commonly used in the wheels of automobile vehicles in order to wholly or partially cover the metal rim for its protection and of the bushing in which that wheel is fitted. The hubcap fitted on the wheel rim protects the bushing from knocks and flying stones and foreign bodies, extending its protection to elements such as the brake mechanism and the suspension, it reduces aerodynamic noise and it also enhances the appearance of the vehicle in general.

The rims of the wheels are fastened to the bushing of the suspension by means of threaded screws or by means of nuts provided on screws projecting from that bushing.

The location of the screws or nuts for the fastening of the wheel to the bushing of the suspension assembly of the car is done one by one, and is an uncomfortable operation for the private user or in a small repair workshop. Only large manufacturers of automobiles have specific machines permitting all the screws or nuts to be introduced simultaneously by specialised operators in the assembly line. In this assembly, the installation of the hubcap has to be borne in mind, which is sometimes fastened between the screws and the wheel rim, with which the assembly operation becomes complicated.

A relevant background art can be found in document U.S. Pat. No. 5,520,445, which discloses a wheel cover retention system for use in motor vehicle wheels. This system includes a plurality of lug nuts and a wheel cover. Each lug nut has a decorative outer surface with a flange and a driving head which includes wrenching flats. The driving head sustains the installation torque required to fix the wheel to a vehicle. An intermediate body portion of the lug nut is smaller in diameter than the flange, and it is disposed between the flange and an end of the lug nut. The wheel cover has a plurality of apertures accommodating the passage there-through of the body portion of the lug nuts.

### DESCRIPTION OF THE INVENTION

The hubcap with fastening screws coupled therein intended to be fastened to the wheel rim forming the object of the present registration is characterised in that it comprises a specific arrangement for the continuous retention of the fastening screws or nuts of the wheel in the wheel itself, both when it is fitted and when it is removed. This aspect is highly beneficial since it permits the automobile manufacturer to fit the wheel and the hubcap in less time and with greater facility for the operator. Moreover, the private user and the repair workshop have to handle fewer loose parts when changing the wheel since the hubcap has all the fastening screws or nuts in its interior.

Indeed, the hubcap comprises the classical discoid element for covering the wheel rim, made of a resistant material such as metal sheet or preferably a plastic material such as polyamide or others. This hubcap presents, in coordination with the projecting screws or securing holes for the bushing, certain tubular sleeves or alignment cylinders in which the respective screws or nuts are housed.

Taking as the basis a bushing with projecting studs as the securing means for the wheel, the hubcap comprises threaded screws on each of those studs. The said screws present a different design from standard screws conventionally used. The screws of the new invention are slightly more elongated and consist of an encircling throat or restriction intended for housing a lip existing in the interior of the corresponding receiving sleeve.

This throat will be defined at its front and rear by means of separate stops limiting the travel of the interior lip and they therefore prevent the screw from coming out of the sleeve, retaining it instead. Moreover, the contour of the interior stop of the nut is tight fitting, though it has freedom to slide on the inner surface of the sleeve, the length of which is sufficient so that the nut does not come out when it reaches its maximum penetration. In this way, the nut is perfectly aligned with the projecting stud of the bushing for being screwed, thereby facilitating this operation.

Provision has been made for the lip encircling the sleeve to have its interior contour inclined, fitting with the exterior contour of the rear stop of the throat close to the head of the screw. This inclination of the lip in the sleeve and the stop of the throat in the nut permits said nut to be able to be introduced by easily forcing it into the hubcap during its fitting prior to being supplied to the client. Once fitted, the screw permits the installation of the hubcap on the wheel and prevents that hubcap from being removed without being broken or deformed if the proper tools are not being used.

When the hubcap is removed from the wheel, the nuts move longitudinally in the interior of the corresponding sleeve, limited by the travel of the interior lip of the sleeve between the two stops of the throat. In this way, none of the nuts can come out of the hubcap when the latter is removed.

The fitting of the hubcap is simplified since it is merely necessary to locate the hubcap on the wheel rim and it is automatically centred by means of some support clips in the flanges of the rim. Once the hubcap has been centred, the nuts are tightened on the studs of the bushing one by one.

When the hubcap is installed on the rim of the wheel, the nuts secure the hubcap by means of the interference existing between the lip of the sleeve and the stop of the throat close to the external head of the nut. This interference is carried out on the basis of the straight facing contours of the lip of the sleeve and the stop of the throat. The arrangement of that stop is calculated so that there exists a certain compression and bending of the hubcap against the wheel rim, optimising its fastening.

Equally, the removal of the hubcap is also simple, with each of the nuts being unscrewed. Once they have been released from the stud, the nuts continue to be retained in the interior of the sleeve with which, at the end of the unscrewing operation, they are extracted together with the hubcap.

The entire description has been made taking as a basis the fact that the securing of the wheel rim to the bushing is done by means of nuts on studs projecting from that bushing. But the new invention is also applicable to the alternative system of securing by threaded screws on holes existing in the bushings. It is merely necessary for the screw to be adapted to the said throat for the same invention to be able to be used on those wheels.

In order to complete the description that is going to be made forthwith, and with the aim of aiding a better understanding of its characteristics, this specification is accompanied by a set of figures in which, in an illustrative and non-limiting way, the most significant details of the invention are represented.

### BRIEF DESCRIPTION OF THE DRAWINGS

FIG. 1. Shows a sectioned view of a hubcap of the new invention.

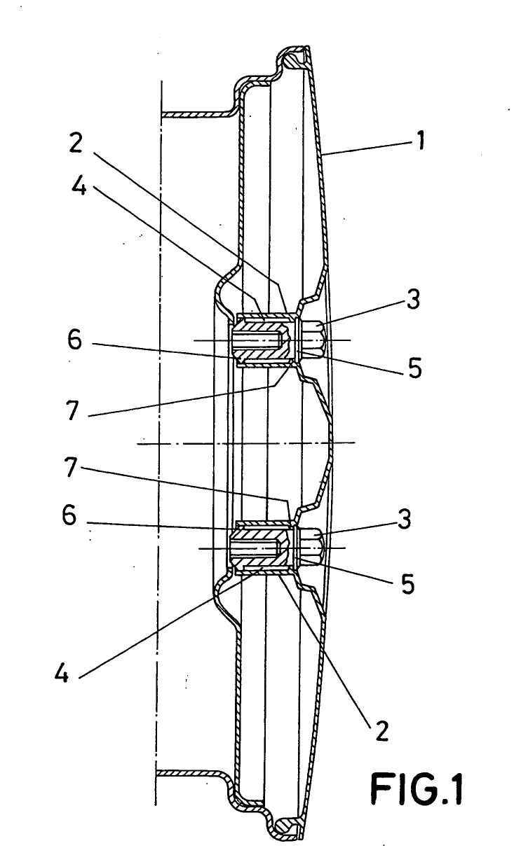

FIG. 2. Shows a sectioned view of a housing detail of a nut in the sleeve.

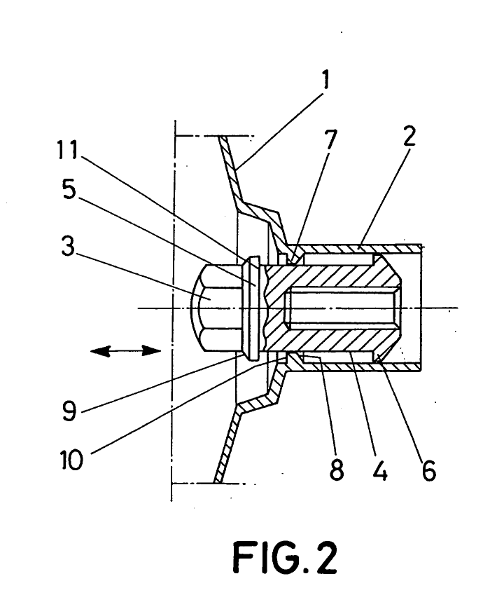

FIG. 3. Shows a sectioned view of a housing detail of a screw in the sleeve.

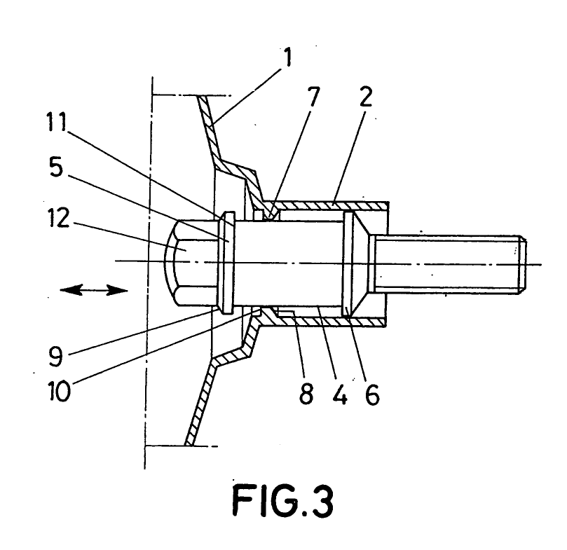

### DESCRIPTION OF AN EMBODIMENT OF THE INVENTION

Looking at the said figures, and in accordance with the adopted numbering, in them can be seen a preferred though not limiting embodiment of the invention, which consists of a discoid type or similar hubcap which, with each of the securing studs existing in the hub of the suspension assembly, comprises a coaxial cylindrical sleeve (2), projecting from the casing (1) towards the interior, in which is housed a nut (3) for fastening the wheel rim to that hub, also arranged co-axially. Said sleeve (2) presents, close to its exterior opening, an encircling projecting lip (7), the interior contour (8) of which is conical in shape and its exterior contour (10) is flushed perpendicular to the axis of the sleeve (2). The nut (3) presents in its contour a throat (4) or cylindrical encircling restriction, demarcated between two end stops (5 and 6). The lip (7) of the sleeve (2) is housed in the interior of that throat (4) of the nut (3) defined by the stops (5 and 6), the encircling contour of the stop (6) being in turn in sliding contact with the interior surface of the sleeve (2). The interior contour (11) of the stop (5) is flushed perpendicular with the axis of the sleeve (2) and facing the contour (10) of the lip (7), while the exterior contour (9) of the stop (5) has a conical shape matching the contour (8) of the lip (7).

In an alternative embodiment, the nuts (3) housed in the sleeves (2) of the hubcap (1) can be replaced with screws (12) for their securing in holes presented in the hub of the suspension assembly of the wheel. In an analogous fashion, these screws (12) present an identical arrangement with an encircling throat (4) demarcated by two stops (5 and 6).

1. HUBCAP WITH FASTENING ELEMENTS COUPLED THEREIN for use in automobile vehicles or the like, said fastening elements (3, 12) being selected from screws (12) and nuts (3) in order to fasten said hubcap to a wheel rim and to a hub of the wheel;
said hubcap comprising a casing (1) that trims and covers at least part of a wheel rim,
said casing (1) comprising integral sleeves (2) provided with an internal surface,
each of said sleeves (2) comprising in turn, retention means implemented by means of an encircling lip (7) arranged on the internal surface of the sleeve (2) in a position close to an opening of said sleeve (2); and
each of the fastening elements (3, 12) being provided in its encircling contour with a restriction throat (4) delimited by two encircling projecting stops (5, 6): an external stop (5) and an internal stop (6),
said throat (4) housing between said two stops (5, 6) the lip (7) of the sleeve (2) tightly but slidably, in order to prevent the fastening elements (3, 12) from coming out of the hubcap when said hubcap is removed from the wheel; characterised in that:
said lip (7) is arranged close to an external opening of the sleeve (2), and
an exterior contour of the internal stop (6) of the fastening element (3, 12) is in contact with the internal surface of said sleeve (2), keeping said fastening element (3, 12) coaxial together with the lip (7) of the sleeve (2), in order to enable a centred coaxial relative movement between said sleeve (2) and said fastening element (3, 12).

2. HUBCAP WITH FASTENING ELEMENTS COUPLED THEREIN, according to claim 1, characterised in that:
the lip (7) is provided with an internal contour (8) having a conical shape, and with an external contour (10) having an even shape which is perpendicular to the sleeve (2); and
the external stop (5) is provided with an internal contour (11) having an even shape which is perpendicular to the sleeve (2) and confronted with the external contour (10) of the lip (7) of said sleeve (2) in order to secure the hubcap (1); and
the external stop (5) is also provided with an external contour (9) which matches the internal contour (8) of the lip (7) in order to enable an assembly of the fastening elements (3, 12) within the sleeve (2).

3. HUBCAP WITH FASTENING ELEMENTS COUPLED THEREIN, according to claim 1, characterised in that the hubcap (1) is provided with elements selected from clips and flanges for self-centring on the wheel rim, enabling each of the fastening elements (3, 12) to face their corresponding securing holes and studs in the hubcap.

4. HUBCAP WITH FASTENING ELEMENTS COUPLED THEREIN, according to claim 2, characterised in that the hubcap (1) is provided with elements selected from clips and flanges for self-centring on the wheel rim, enabling each of the fastening elements (3, 12) to face their corresponding securing holes and studs in the hubcap.
